(19) United States
(12) Patent Application Publication
(10) Pub. No.: US 2026/0073866 A1
(43) Pub. Date: Mar. 12, 2026

(54) DISPLAY DEVICE AND ELECTRONIC DEVICE INCLUDING THE SAME

(71) Applicant: Samsung Display Co., LTD., Yongin-si (KR)

(72) Inventors: KYUNG-BAE KIM, Yongin-si (KR); JANGMI KANG, Yongin-si (KR); JINSEON KWAK, Yongin-si (KR); KyeongMin Park, Yongin-si (KR)

(21) Appl. No.: 19/219,056

(22) Filed: May 27, 2025

(30) Foreign Application Priority Data
Sep. 9, 2024 (KR) 10-2024-0122065

(51) Int. Cl. G09G 3/3233

(52) U.S. Cl. CPC G09G 3/3233; G09G 2300/0819; G09G 2300/0852; G09G 2300/0861; G09G 2330/021; G09G 2330/028

(57) ABSTRACT

A display device includes a display panel including a plurality of pixels, a gate driver configured to output a gate signal to the pixels, a data driver configured to apply a data voltage to the pixels and a voltage generator configured to output a compensated power voltage to the pixels. The pixels are connected to a compensated power voltage line. The voltage generator includes a high power voltage generating block configured to output a high power voltage to a voltage drop block and the voltage drop block, which outputs the compensated power voltage lower than the high power voltage to the compensated voltage line.

This application claims priority to Korean Patent Application No. 10-2024-0122065, filed on Sep. 9, 2024, and all the benefits accruing therefrom under 35 U.S.C. § 119, the content of which in its entirety is herein incorporated by reference.

### BACKGROUND

### 1. Field

Embodiments of the present invention relate to a display device and an electronic device including the same. More particularly, embodiments of the present invention relate to a display device improving an emission reliability.

### 2. Description of the Related Art

Generally, a display device includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines and a driving controller controlling the gate driver, the data driver and the emission driver.

### SUMMARY

Embodiments of the present invention provide a display device improving an emission reliability.

Embodiments of the present invention also provide an electronic device improving an emission reliability.

According to embodiments, a display device includes a display panel including a plurality of pixels, a gate driver configured to output a gate signal to the pixels, a data driver configured to apply a data voltage to the pixels and a voltage generator configured to output a compensated power voltage to the pixels. The pixels are connected to a compensated power voltage line. The voltage generator includes a high power voltage generating block configured to output a high power voltage to a voltage drop block and the voltage drop block, which outputs the compensated power voltage lower than the high power voltage to the compensated voltage line.

In an embodiment, the voltage drop block may include a voltage drop element. The voltage drop element may include a first electrode, which receives the high power voltage and a second electrode connected to the compensated power voltage line.

In an embodiment, the voltage drop element may be a voltage drop transistor. The voltage drop transistor may include a control electrode connected to the compensated power voltage line, a first electrode, which receives the high power voltage and a second electrode connected to the compensated power voltage line.

In an embodiment, a pixel region on which a pixel of the pixels is located may have a first size. A voltage drop region on which the voltage drop transistor is located may have the first size.

In an embodiment, the pixel may include first to third sub-pixels. The first to third pixels may be located on the pixel region having the first size.

In an embodiment, a size of the voltage drop transistor may have the first size.

In an embodiment, a pixel region on which a pixel of the pixels is located may have a first size. The pixel of the pixels may include a sub-pixel. A sub-pixel region on which the sub-pixel is located may have a second size smaller than the first size. A voltage drop region on which the voltage drop transistor is located may have the second size.

In an embodiment, a size of the voltage drop transistor may have the second size.

In an embodiment, the display device may further include further comprising an emission driver configured to output an emission signal to the pixels. A pixel of the pixels may include a sub-pixel. The sub-pixel may include a first transistor including a control electrode connected to a first node, a first electrode connected to a second node and a second electrode connected to a third node, a second transistor configured to apply the data voltage to the first node in response to a write gate signal, a third transistor configured to apply the compensated power voltage to the second node in response to the emission signal, a fourth transistor configured to output an initialization voltage to the third node in response to a control gate signal and a light emitting element including a first electrode connected to the third node and a second electrode, which receives a low power voltage.

In an embodiment, the second transistor may include a control electrode, which receives the write gate signal, a first electrode, which receives the data voltage and a second electrode connected to the first node. The third transistor may include a control electrode, which receives the emission signal, a first electrode, which receives the compensated power voltage and a second electrode connected to the second node. The fourth transistor may include a control electrode, which receives the control gate signal, a first electrode, which receives the initialization voltage and a second electrode connected to the third node.

In an embodiment, the sub-pixel may further include a first capacitor including a first electrode connected to the first node and a second electrode connected to the second node, a second capacitor including a first electrode connected to the first node and a second electrode, which receives the initialization voltage and a third capacitor including a first electrode connected to the first node and a second electrode connected to the third node.

In an embodiment, the voltage drop block may include a first voltage drop transistor and a second voltage drop transistor. The first voltage drop transistor may include a control electrode connected to the compensated voltage power voltage line, a first electrode, which receives the high power voltage and a second electrode connected to the compensated power voltage line. The second voltage drop transistor may include a control electrode connected to the compensated voltage power voltage line, a first electrode, which receives the high power voltage and a second electrode connected to the compensated power voltage line.

In an embodiment, the display panel may include a display region on which the pixels are located, and a peripheral region located adjacent to the display region. The voltage drop block may be located on the peripheral region.

In an embodiment, the pixels may be located on a silicon-based substrate.

According to embodiments, a display device includes a display region including a first sub-pixel and a second sub-pixel and a panel driver configured to drive the display region. The panel driver includes a voltage generator configured to apply a compensated power voltage to the display panel. The voltage generator includes a voltage drop element including a first electrode, which receives a high power voltage and a second electrode connected to a compensated power voltage line. The first sub-pixel and the second sub-pixel are connected to the second electrode of the voltage drop element.

In an embodiment, the first sub-pixel may include a first sub-driving transistor configured to generate a first sub-driving current based on a data voltage and the compensated power voltage, a first sub-emission transistor configured to apply the compensated power voltage to the first sub-driving transistor in response to an emission signal and a first sub-light emitting element configured to emit light based on the first sub-driving current. The second sub-pixel may include a second sub-driving transistor configured to generate a second sub-driving current based on the data voltage and the compensated power voltage, a second sub-emission transistor configured to apply the compensated power voltage to the second sub-driving transistor in response to the emission signal and a second sub-light emitting element configured to emit light based on the second sub-driving current. A first electrode of the first sub-emission transistor and a first electrode of the second sub-emission transistor may be connected to the second electrode of the voltage drop element.

In an embodiment, the voltage drop element may be a voltage drop transistor. The voltage drop transistor may include a control electrode connected to the compensated power voltage line, a first electrode, which receives the high power voltage and a second electrode connected to the compensated power voltage line.

In an embodiment, a first sub-pixel region on which the first sub-pixel is located may have a second size. A voltage drop region on which the voltage drop element is located may have the second size.

In an embodiment, a size of the voltage drop transistor may have the second size.

In an embodiment, the display panel may include a display region on which the pixels are located, and a peripheral region located adjacent to the display region. The voltage drop block may be located on the peripheral region.

According to embodiments, an electronic device includes a display panel including a plurality of pixels, a gate driver configured to output a gate signal to the pixels, a data driver configured to apply a data voltage to the pixels, a voltage generate configured to output a compensated power voltage to the pixels, a driving controller configured to control the gate driver, the data driver, the voltage generator based on an input control signal and a processor configured to output the input control signal. The pixels are connected to a compensated power voltage line. The voltage generator includes a high power voltage generating block configured to output a high power voltage to a voltage drop block and the voltage drop block, which outputs the compensated power voltage lower than the high power voltage to the compensated voltage line.

As described above, a driving transistor of pixel included in a display device may generate a driving current based on a compensated power voltage lower than a high power voltage. Accordingly, an absolute value of VGS of the driving transistor may be reduced. Accordingly, the magnitude of the driving current may be reduced. As used herein, “VGS” is a voltage between a gate electrode and a source electrode of the transistor. Accordingly, the slope of the voltage-current function of the display device may be smaller than the slope of the voltage-current function of a conventional display device. Accordingly, a data range of the display device may be wider than the data range of the conventional display device. For example, even if the voltage of control electrode of the driving transistor is changed due to leakage current, a sub-pixel may emit light as substantially same grayscale. Accordingly, a visibility of the bright line of the display panel may be reduced. Accordingly, an emission reliability of the display panel may be effectively improved.

Additionally, a voltage drop element of a voltage drop block included in a display device may be a voltage drop diode, so that a current may not flow from the compensated power voltage line to the high power voltage line. Accordingly, when the sub-pixel emits light, the compensated power voltage may be maintained as a substantially same voltage. Additionally, when the sub-pixel emits light, the compensated power voltage may be maintained as a substantially same voltage. Accordingly, an emission reliability of the sub-pixel may be effectively improved.

Additionally, a size of a voltage drop transistor of the voltage drop block may be substantially same as a size of the pixel. Accordingly, a size of a channel region of the voltage drop transistor may be greater than a size of a channel region of the driving transistor. Accordingly, a dispersion of a threshold voltage of the voltage drop transistor may be decreased. The dispersion of the threshold voltage of the voltage drop transistor may be decreased, when the sub-pixel emits light, the compensated power voltage may be maintained substantially same voltage. Accordingly, the emission reliability of the sub-pixel may be effectively improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present invention.

FIG. 2 is a block diagram illustrating an example of a display panel and a voltage generator included in a display device of FIG. 1.

FIG. 3 is a block diagram illustrating sub-pixel SPX included in a pixel of FIG. 1.

FIG. 4 is a circuit diagram illustrating an example of a sub-pixel of FIG. 3.

FIG. 5 is a circuit diagram illustrating an example of a display panel and a voltage generator of FIG. 1.

FIG. 6 is a graph illustrating a function of a data voltage and a driving current.

FIG. 7 is a graph illustrating a data range according to a gray scale.

FIG. 8 is a circuit diagram illustrating an example of a display panel and a voltage generator of FIG. 1.

FIG. 9 is a plan view illustrating an example of a location of a pixel of FIG. 1 and a voltage drop transistor of FIG. 6.

FIG. 10 is a plan view illustrating an example of a location of a pixel of FIG. 1 and a voltage drop transistor of FIG. 6.

FIG. 11 is a circuit diagram illustrating an example of a display panel and a voltage generator of FIG. 1.

FIG. 12 is a diagram illustrating an example in which a pixel of FIG. 1 is located on a substrate.

FIG. 13 is a block diagram illustrating an electronic device according to an embodiment of the present invention.

FIG. 14 is a diagram illustrating an example in which the electronic device of FIG. 13 is implemented as a smart phone.

FIG. 15 is a diagram illustrating an example in which the electronic device of FIG. 13 is implemented as a virtual reality display system.

### DETAILED DESCRIPTION

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Hereinafter, the present invention will be explained in detail with reference to the accompanying drawings.

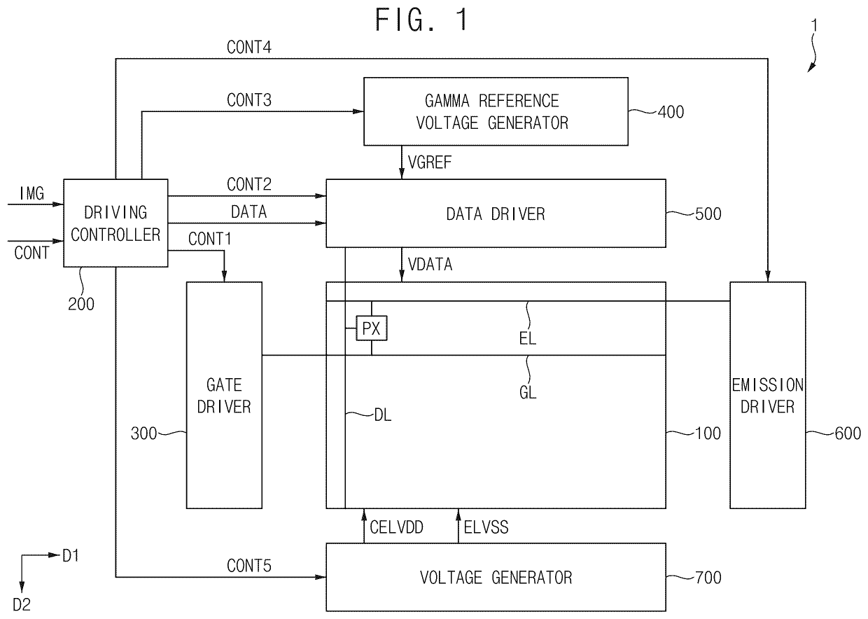

FIG. 1 is a block diagram illustrating a display device 1 according to embodiments of the present invention.

Referring to FIG. 1, the display device 1 may include a display panel 100 and a panel driver. The panel driver may include a driving controller 200, a gate driver 300, a gamma reference voltage generator 400, a data driver 500, an emission driver 600 and a voltage generator 700.

The display panel 100 may have a display region on which an image is displayed (e.g., pixels are located in the display region) and a peripheral region adjacent to the display region and on which an image is not displayed (e.g., no pixel is located in the peripheral region).

The display panel 100 may include a plurality of gate lines GL, a plurality of data lines DL, a plurality of emission lines EL and a plurality of pixels PX electrically connected to the gate lines GL, the data lines DL and the emission lines EL. The gate lines GL may extend in a first direction D1. The data lines DL may extend in a second direction D2 crossing the first direction D1. The emission lines EL may extend in the first direction D1.

The driving controller 200 may receive input image data IMG and an input control signal CONT from an external device. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The driving controller 200 may generate the fifth control signal CONT5 for controlling an operation of the voltage generator 700 based on the input control signal CONT, and output the fifth control signal CONT5 to the voltage generator 700.

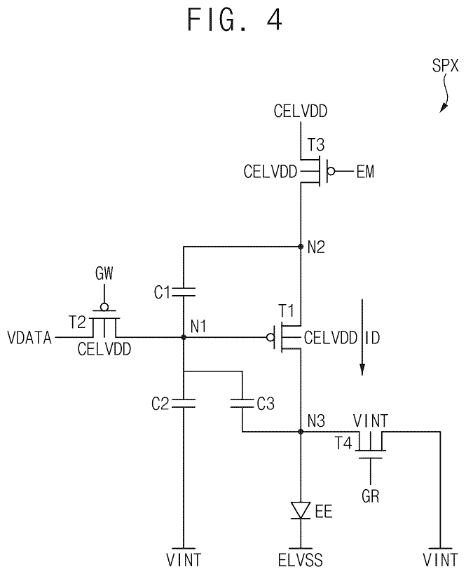

The gate driver 300 may generate gate signals driving the gate lines GL in response to the first control signal CONT1 received from the driving controller 200. The gate driver 300 may receive a gate high voltage and a gate low voltage from the voltage generator 700. The gate driver 300 may output the gate signals to the gate lines GL. For example, the gate signals may include a control gate signal GR of FIG. 4 and a write gate signal GW of FIG. 4.

In an embodiment, the gate driver 300 may be disposed in the peripheral region. In an embodiment, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL.

In an embodiment, the data driver 500 may be disposed in the peripheral region. In an embodiment, the data driver 500 may be integrated in the peripheral region.

The emission driver 600 may generate emission signal EM of FIG. 4 in response to the fourth control signal CONT4 received from the driving controller 200. The emission driver 600 may output the emission signal EM of FIG. 4 to the display panel 100.

In an embodiment, the emission driver 600 may be disposed in the peripheral region.

In an embodiment, the emission driver 600 may be integrated in the peripheral region.

Although the gate driver 300 is disposed on a first side of the display panel 100, and the emission driver 600 is disposed on a second side of the display panel 100 in FIG. 1 for convenience of explanation, the present invention is not limited thereto. The gate driver 300 and the emission driver 600 may be disposed on the first side of the display panel 100. For example, the gate driver 300 and the emission driver 600 may be disposed on the peripheral region of the display panel 100 on the same side of the display region of the display panel 100. For example, the gate driver 300 and the emission driver 600 may be formed integrally with each other.

In an embodiment, the voltage generator 700 may output a compensated power voltage CELVDD and a low power voltage ELVSS to the display panel 100 in response to the fifth control signal CONT5 received from the driving controller 200.

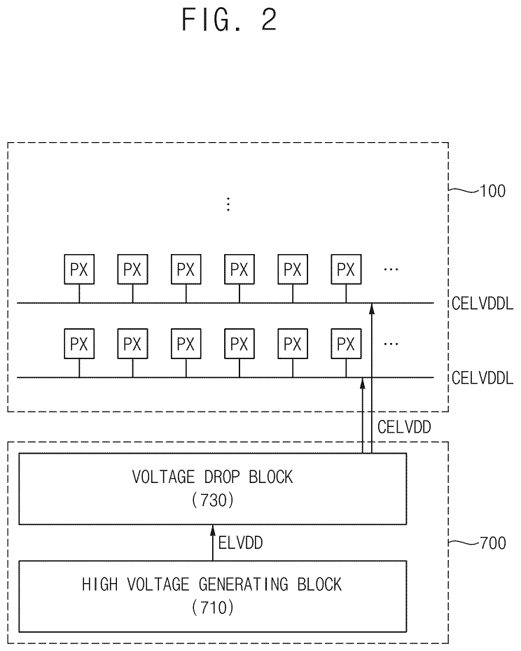

FIG. 2 is a block diagram illustrating an example of a display panel 100 and a voltage generator 700 included in a display device 1 of FIG. 1.

Referring to FIG. 1 and FIG. 2, the display panel 100 may include pixels PX and a compensated power voltage line CELVDDL. The pixels PX may be connected to the compensated power voltage line CELVDDL. The compensated power voltage line CELVDDL may output the compensated power voltage CELVDD to the pixels PX. In an embodiment, the compensated power voltage line CELVDDL may have a mesh structure. However, the present invention is not limited to a structure of the compensated power voltage line CELVDDL.

The voltage generator 700 may include a high power voltage generating block 710 and a voltage drop block 730. The high power voltage generating block 710 (e.g., high power voltage generator) may output the high power voltage ELVDD to the voltage drop block 730. The voltage drop block 730 may generate the compensated power voltage CELVDD based on the high power voltage ELVDD. The voltage drop block 730 may output the compensated power voltage CELVDD to the compensated power voltage lines CELVDDL. The compensated power voltage CELVDD may be lower than the high power voltage ELVDD.

In the present embodiment, the pixels PX may receive the compensated power voltage CELVDD lower than the high power voltage ELVDD. Accordingly, the pixels PX may emit light based on the compensated power voltage CELVDD and the data voltage VDATA.

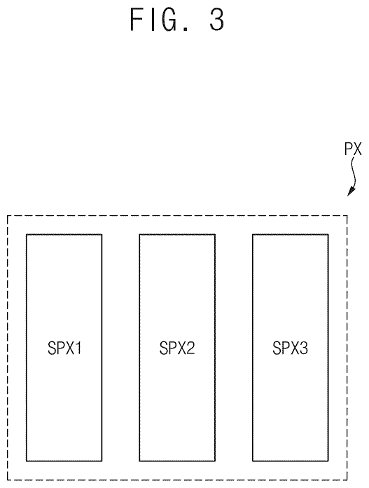

FIG. 3 is a block diagram illustrating sub-pixel SPX included in a pixel PX of FIG. 1. FIG. 4 is a circuit diagram illustrating an example of a sub-pixel SPX of FIG. 3.

Referring to FIG. 1 to FIG. 4, the pixel PX may include sub-pixels SPX1, SPX2 and SPX3. For example, the pixel PX may include a first sub-pixel SPX1, a second sub-pixel SPX2 and a third sub-pixel SPX3. However, the present invention is not limited to the number of the sub-pixels included in the pixel PX. For example, the pixel PX may further include a fourth sub-pixel. For example, the first sub-pixel SPX1 may be a red sub-pixel. For example, the red sub-pixel may emit as red. For example, the second sub-pixel SPX2 may be a green sub-pixel. For example, the green sub-pixel may emit as green. For example, the third sub-pixel may be a blue sub pixel. For example, the blue sub-pixel may emit as blue. However, the present invention is not limited to colors of the sub-pixels SPX1, SPX2 and SPX3.

The sub pixel SPX may include a first transistor T1, a second transistor T2, a third transistor T3, a fourth transistor T4, a first capacitor C1, a second capacitor C2, a third capacitor C3 and a light emitting element EE. For example, the sub-pixel SPX may have a four transistors and three capacitors (“4T-3C”) structure. The first to fourth transistors T1 to T4 may be dual gate transistors.

The first transistor T1 may include a control electrode connected to a first node N1, a first electrode connected to a second node N2 and a second electrode connected to a third node N3. In an embodiment, the first transistor T1 may further include a second control electrode connected to the compensated power voltage CELVDD. The first transistor T1 may generate a driving current ID based on a voltage of the first node N1. For example, the first transistor T1 may generate the driving current ID based on the voltage of the first node N1 and a voltage of the second node N2. For example, the first transistor T1 may be called as a “driving transistor”.

The second transistor T2 may include a control electrode, which receives the write gate signal GW, a first electrode, which receives the data voltage VDATA and a second electrode connected to the first node N1. In an embodiment, the second transistor T2 may further include a second control electrode, which receives the compensated power voltage CELVDD. The second transistor T2 may apply the data voltage VDATA to the first node N1 in response to the write gate signal GW. For example, the second transistor T2 may be called as a “write transistor”.

The third transistor T3 may include a control electrode, which receives the emission signal EM, a first electrode, which receives the compensated power voltage CELVDD and a second electrode connected to second node N2. In an embodiment, the third transistor T3 may further include a second control electrode, which receives the compensated power voltage CELVDD. The third transistor T3 may apply the compensated power voltage CELVDD to the second node N2 in response to the emission signal EM. The third transistor T3 may connect the compensated power voltage line CELVDDL and the second node N2 in response to the emission signal EM. For example, the third transistor T3 may be called as an “emission transistor”.

The fourth transistor T4 may include a control electrode, which receives the control gate signal GR, a first electrode, which receives an initialization voltage VINT and a second electrode connected to the third node N3. In an embodiment, the third transistor T3 may further include a second control electrode, which receives the compensated power voltage CELVDD. The fourth transistor T4 may apply the initialization voltage VINT to the third node N3 in response to the control gate signal GR. For example, the initialization voltage VINT may be lower than a low power voltage ELVSS. The initialization voltage VINT may be lower than the low power voltage ELVSS, so that a black characteristic of the light emitting element EE may be improved.

The first capacitor C1 may include a first electrode connected to the first node N1 and a second electrode connected to the second node N2. The second capacitor may include a first electrode connected to the first node N1 and a second electrode, which receives the initialization voltage VINT. The third capacitor C3 may include a first electrode connected to the first node N1 and a second electrode connected to the third node N3.

The light emitting element EE may include a first electrode connected to the third node N3 and a second electrode, which receives the low power voltage ELVSS. The light emitting element EE may emit light based on the driving current ID. In an embodiment, the light emitting element EE may be an organic light emitting diode (“OLED”), but not limited thereto. In other embodiments, the light emitting element EE may be a nano light emitting diode (“NED”), a quantum dot (“QD”) light emitting diode, a micro light emitting diode, an inorganic light emitting diode, or any other suitable light emitting element.

In the present embodiment, the first to third transistors T1, T2 and T3 may be first type transistors. The fourth transistor T4 may be a second type transistor. For example, the first type transistor may be a polysilicon thin film transistor. For example, the first type transistor may be a low temperature polysilicon (LTPS) thin film transistor. For example, the second type transistor may be an oxide thin film transistor. For example, the first type transistor may be a P-type transistor, and the second type transistor may be an N-type transistor. In the present embodiment, some of the transistors of the sub-pixel SPX are oxide thin film transistors and other some of the transistors are polysilicon thin film transistors, but the present invention is not limited thereto. In an embodiment, the present invention may also be applied to a pixel including only oxide thin film transistors. In the present embodiment, some of the transistors of the pixel are N-type transistors and other some of the transistors are P-type transistors, but the present invention is not limited thereto. For example, the present invention may be applied to a pixel including only N-type transistors. For example, the present invention may be applied to a pixel including only P-type transistors.

In present embodiment, the fourth transistor T4 may be an N-type transistor, so that the initialization voltage VINT may be applied to the third node N3 without a difference equal to a threshold voltage of the fourth transistor T4. For example, the third node N3 may receive a voltage substantially same as the initialization voltage VINT. Accordingly, a black characteristic of the sub-pixel SPX may be improved.

Additionally, in the present embodiment, the sub-pixel SPX may have a 4T-3C structure, so that an integration may be improved. Accordingly, the display device 1 may be applied to an ultra-high resolution display device.

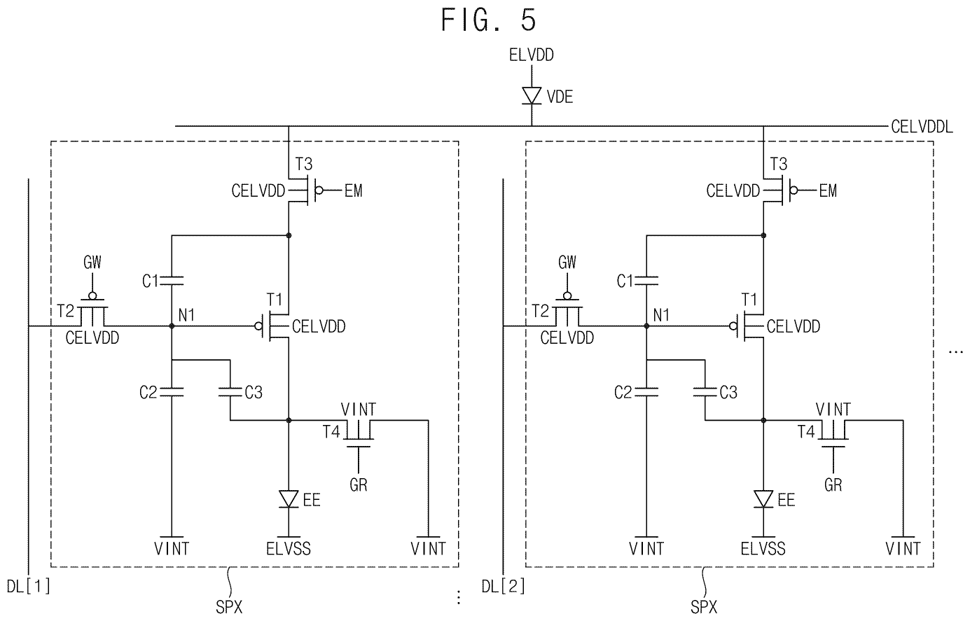

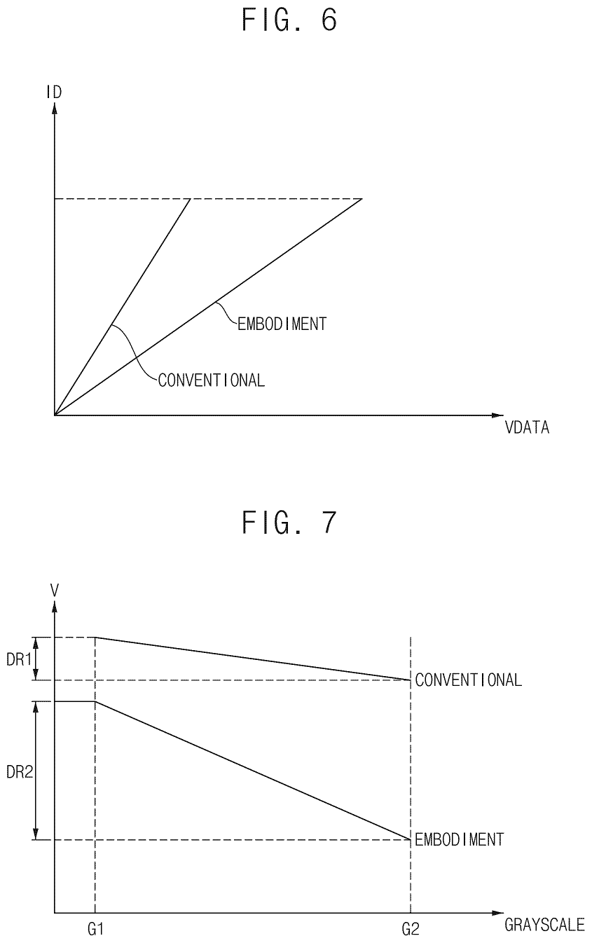

FIG. 5 is a circuit diagram illustrating an example of a display panel 100 and a voltage generator 700 of FIG. 1. FIG. 6 is a graph illustrating a function of a data voltage VDATA and a driving current ID. FIG. 7 is a graph illustrating a data range according to a gray scale.

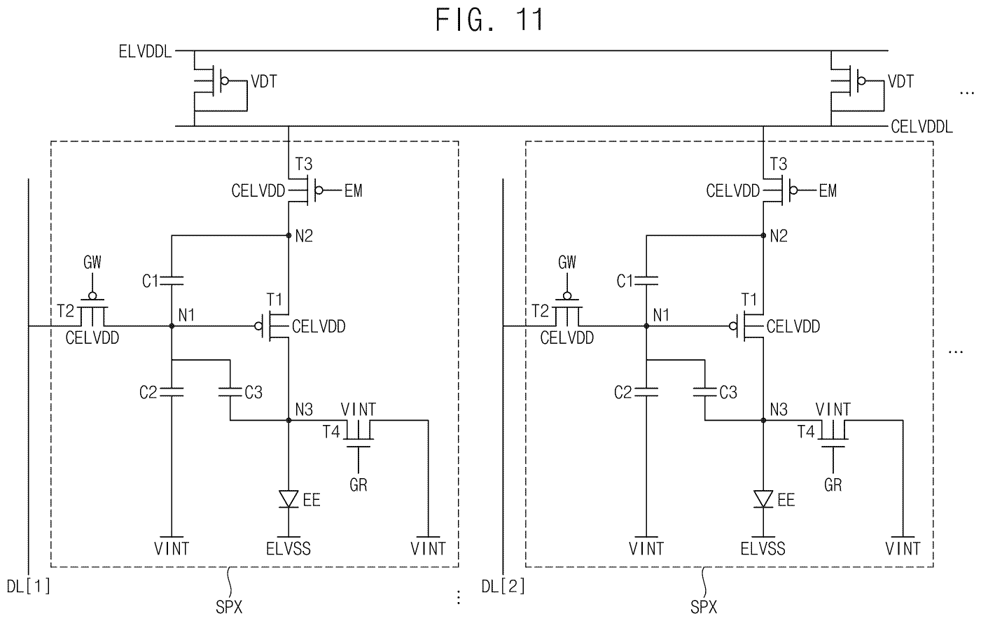

Referring to FIG. 1 to FIG. 5, the voltage drop block 730 may include a voltage drop element. The voltage drop element may receive the high power voltage ELVDD. The voltage drop element may output the compensated power voltage CELVDD based on the high power voltage ELVDD. The voltage drop element may output the compensated power voltage CELVDD to the compensated power voltage line CELVDDL. The voltage drop element may connect the high power voltage line ELVDDL of FIG. 11 and the compensated power voltage line CELVDDL. The above voltage drop element may have a resistance. Accordingly, the voltage drop element may be receive the high power voltage ELVDD and output a compensated power voltage CELVDD lower than the high power voltage ELVDD.

In the present embodiment, the pixel PX may include a first sub-pixel SPX (e.g., left sub-pixel in FIG. 5) and a second sub-pixel SPX (e.g., right sub-pixel in FIG. 5). The first sub-pixel SPX may be connected to the first data line DL [1]. The second sub-pixel SPX may be connected to the second data line DL [2]. Additionally, the first sub-pixel SPX and the second sub-pixel SPX may be connected to the compensated power voltage line CELVDDL.

The first sub-pixel SPX may include a first sub-driving transistor T1, which generates a first sub-driving current based on the data voltage VDATA and the compensated power voltage CELVDD, a first sub-emission transistor T3, which applies the compensated power voltage CELVDD to the first sub-driving transistor T1 in response to the emission signal EM and a first sub-light emitting element EE, which emits light based on the first sub-driving current. The second sub-pixel SPX may include a second sub-driving transistor T1, which generates a second sub-driving current based on the data voltage VDATA and the compensated power voltage CELVDD, a second sub-emission transistor T3, which applies the compensated power voltage CELVDD to the second sub-driving transistor T2 in response to the emission signal EM and a second sub-light emitting element EE, which emits light based on the second sub-driving current.

In the present embodiment, the voltage drop element may be a voltage drop diode VDE. The voltage drop diode VDE may include a first electrode, which receives the high power voltage ELVDD and a second electrode connected to the compensated power voltage line CELVDDL. In the present embodiment, the voltage drop element may be the voltage drop diode VDE, so that a current may not flow from the compensated power voltage line CELVDDL to the high power voltage line ELVDDL. Additionally, when the sub-pixel SPX emits light, the compensated power voltage CELVDD may be maintained as the substantially same voltage (i.e., keep the same voltage). Accordingly, an emission reliability of the sub-pixel SPX may be effectively improved.

A first electrode (e.g., source electrode) of a conventional driving transistor may receive the high power voltage ELVDD. The conventional driving transistor may generate a driving current based on the high power voltage ELVDD and a data voltage.

However, in the present embodiment, the compensated power voltage CELVDD may be lower than the high power voltage ELVDD. Accordingly, a voltage applied to the first electrode of the first transistor T1 may be lower than the high power voltage ELVDD. Accordingly, an absolute value of VGS of the first transistor T1 may be reduced. The absolute value of VGS may be reduced, so that a data range may be increased. The data range may be a range of the data voltage VDATA. For example, the high power voltage ELVDD may be about 10V, and the compensated power voltage CELVDD may be about 8V. For example, when the data voltage VDATA is about 5V, an absolute value of VGS of the conventional driving transistor may be about 5V, and the absolute value of VGS of the first transistor T1 in an embodiment may be about 3V. For example, when the data voltage VDATA is about 3V, the absolute value of VGS of the conventional driving transistor may be about 7V, and the absolute value of VGS of the first transistor T1 in an embodiment may be about 5V.

When the data voltage VDATA is applied to the control electrode of the first transistor T1, compared with the conventional driving transistor, the absolute value of VGS of the first transistor T1 in an embodiment may be lower than the absolute value of VGS of the conventional driving transistor. Accordingly, the magnitude of the driving current ID in the embodiment may be reduced. Accordingly, the slope of the voltage-current function representing the relationship between the data voltage VDATA and the driving current ID of the conventional display device and the slope of the voltage-current function of the display device 1 according to the present invention may be different. For example, the slope of the voltage-current function of the display device 1 may be smaller than the slope of the voltage-current function of the conventional display device. Accordingly, the data range of the display device 1 may be wider than the data range of the conventional display device.

For example, the data range may be a range from a voltage corresponding to the first grayscale G1 to a voltage corresponding to the second grayscale G2. The second grayscale G2 may be higher than the first grayscale G1. For example, the first grayscale G1 may be about 32 grayscale level. For example, the second grayscale G2 may be about 255 grayscale level. However, the present invention is not limited to values of the first grayscale G1 and the second grayscale G2. The conventional display device may have a first data range DR1. The display device 1 according to the present invention may have a second data range DR2. The second data range DR2 may be wider than the first data range DR1. Accordingly, when a voltage of the first node N1 in an embodiment of FIG. 4 is changed due to a leakage current, a change in the driving current ID may be small compared to that of the conventional display device. For example, even if the voltage of the first node N1 is changed due to leakage current, the sub-pixel SPX may emit light as substantially same grayscale. Accordingly, a visibility of the bright line of the display panel 100 may be reduced. Accordingly, an emission reliability of the display panel 100 may be effectively improved.

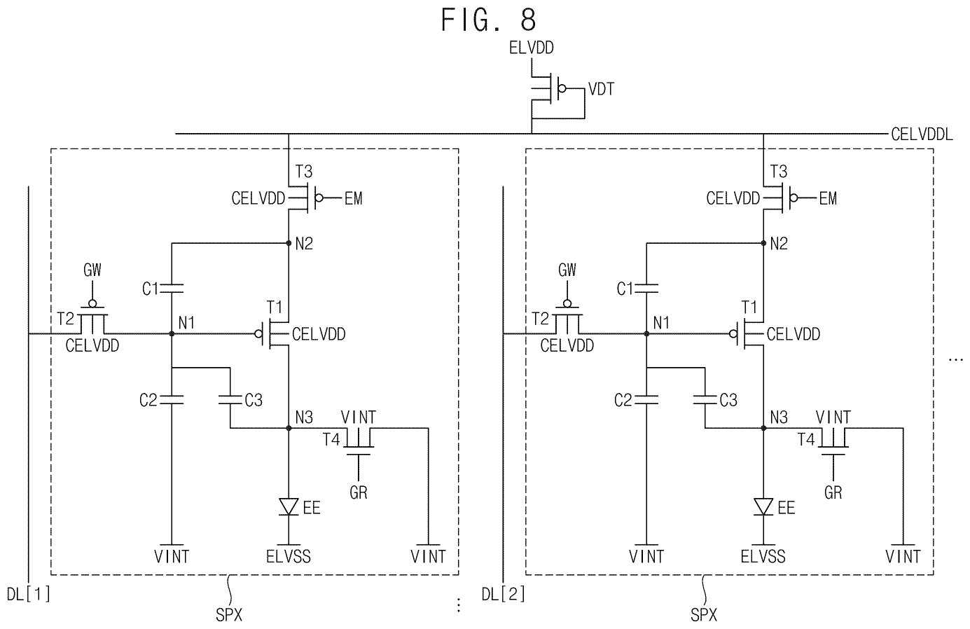

FIG. 8 is a circuit diagram illustrating an example of a display panel 100 and a voltage generator 700 of FIG. 1.

Referring to FIG. 1 to FIG. 4 and FIG. 6 to FIG. 8, the voltage drop block 730 may include a voltage drop element. The voltage drop element may receive the high power voltage ELVDD. The voltage drop element may output the compensated power voltage CELVDD based on the high power voltage ELVDD. The voltage drop element may output the compensated power voltage CELVDD to the compensated power voltage line CELVDDL. The voltage drop element may connect the high power voltage line ELVDDL of FIG. 11 and the compensated power voltage line CELVDDL. The above voltage drop element may have a resistance. Accordingly, the voltage drop element may be receive the high power voltage ELVDD and output a compensated power voltage CELVDD lower than the high power voltage ELVDD.

In the present embodiment, the pixel PX may include a first sub-pixel SPX (e.g., left sub-pixel in FIG. 8) and a second sub-pixel SPX (e.g., left sub-pixel in FIG. 8). The first sub-pixel SPX may be connected to the first data line DL [1]. The second sub-pixel SPX may be connected to the second data line DL [2]. Additionally, the first sub-pixel SPX and the second sub-pixel SPX may be connected to the compensated power voltage line CELVDDL.

The first sub-pixel SPX may include a first sub-driving transistor T1, which generates a first sub-driving current based on the data voltage VDATA and the compensated power voltage CELVDD, a first sub-emission transistor T3, which applies the compensated power voltage CELVDD to the first sub-driving transistor in response to the emission signal EM and a first sub-light emitting element EE, which emits light based on the first sub-driving current. The second sub-pixel SPX may include a second sub-driving transistor T1, which generates a second sub-driving current based on the data voltage VDATA and the compensated power voltage CELVDD, a second sub-emission transistor T3, which applies the compensated power voltage CELVDD to the second sub-driving transistor in response to the emission signal EM and a second sub-light emitting element EE, which emits light based on the second sub-driving current.

In the present embodiment, the voltage drop element may be a voltage drop transistor VDT. The voltage drop transistor VDT may include a first electrode connected to the compensated power voltage line CELVDDL, a first electrode, which receives the high power voltage ELVDD and a second electrode connected to the compensated power voltage line CELVDDL.

In the present embodiment, the control electrode of the voltage drop transistor VDT and the second electrode of the voltage drop transistor VDT may be connected, so that the voltage drop transistor VDT may be operated as a diode. Additionally, the voltage drop transistor VDT may be a P-type transistor. However, the present invention is not limited to a type of the voltage drop transistor VDT. In the present embodiment, the voltage drop element may be the voltage drop transistor VDT, so that a current may not flow from the compensated power voltage line CELVDDL to the high power voltage line ELVDDL. Additionally, when the sub-pixel SPX emits light, the compensated power voltage CELVDD may be maintained as the substantially same voltage (i.e., keep the same voltage). Accordingly, an emission reliability of the sub-pixel SPX may be effectively improved.

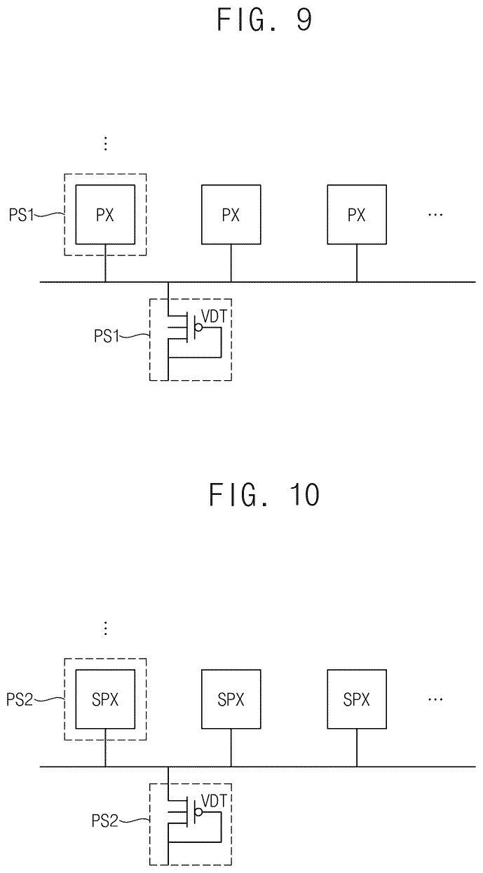

FIG. 9 is a plan view illustrating an example of a location of a pixel PX of FIG. 1 and a voltage drop transistor VDT of FIG. 6.

Referring to FIG. 1 to FIG. 7 and FIG. 9, in the present embodiment, the pixel PX may have a first size PS1. For example, a pixel region on which one pixel PX is located may have the first size PS1. Additionally, in the present embodiment, the voltage drop transistor VDT may have the first size PS1. For example, voltage drop region on which the voltage drop transistor VDT is located may have the first size PS1. In the present embodiment, the size of the pixel region may be substantially same as the size of the voltage drop region. For example, a size of a channel region of the voltage drop transistor VDT may have the first size PS1. The size of the channel region of the voltage drop transistor VDT may be considered as the size of the voltage drop region (i.e., the size of the voltage drop transistor VDT), and sum of the sizes of channel regions of transistors in one pixel PX may be considered as the size of the pixel region.

In the present embodiment, the voltage drop transistor VDT may have the first size PS1, so that the size of the voltage drop transistor VDT may be greater than a size of the first transistor T1. Accordingly, the size of the channel region of the voltage drop transistor VDT may be greater than a size of a channel region of the first transistor T1. Accordingly, a dispersion of a threshold voltage of the voltage drop transistor VDT may be decreased. Since the dispersion of the threshold voltage of the voltage drop transistor VDT may be decreased, when the sub-pixel SPX emits light, the compensated power voltage CELVDD may be maintained substantially same voltage. Accordingly, the emission reliability of the sub-pixel SPX may be effectively improved.

Additionally, in the present embodiment, the voltage drop transistor VDT may be located on the peripheral region. The voltage drop transistor VDT may be located on the peripheral region, so that the size of the voltage drop transistor VDT may not affect the resolution of the display region. Accordingly, the size of the voltage drop transistor VDT may be increased. Accordingly, the threshold voltage dispersion of the voltage drop transistor VDT may be decreased. Accordingly, when the sub-pixel SPX emits light, the compensated power voltage CELVDD may be maintained substantially same voltage. Accordingly, the emission reliability of the sub-pixel SPX may be effectively improved.

FIG. 10 is a plan view illustrating an example of a location of a pixel PX of FIG. 1 and a voltage drop transistor VDT of FIG. 6.

Referring to FIG. 1 to FIG. 7 and FIG. 10, in the present embodiment, one sub-pixel SPX included in the pixel PX may have a second size PS2. For example, a sub-pixel region on which one sub-pixel SPX is located may have the second size PS2. The second size PS2 may be smaller than the first size PS1. Additionally, in the present embodiment, the voltage drop transistor VDT may have the second size PS2. For example, voltage drop region on which the voltage drop transistor VDT is located may have the second size PS2. In the present embodiment, the size of the sub-pixel region may be substantially same as the size of the voltage drop region. For example, a size of a channel region of the voltage drop transistor VDT may have the second size PS2. Sum of the sizes of channel regions of transistors in one sub-pixel SPX may be considered as the size of the pixel region.

In the present embodiment, the voltage drop transistor VDT may have the second size PS2, so that the size of the voltage drop transistor VDT may be greater than a size of the first transistor T1. Accordingly, the size of the channel region of the voltage drop transistor VDT may be greater than a size of a channel region of the first transistor T1. Accordingly, a dispersion of a threshold voltage of the voltage drop transistor VDT may be decreased. Since the dispersion of the threshold voltage of the voltage drop transistor VDT may be decreased, when the sub-pixel SPX emits light, the compensated power voltage CELVDD may be maintained substantially same voltage. Accordingly, the emission reliability of the sub-pixel SPX may be effectively improved.

Additionally, in the present embodiment, the voltage drop transistor VDT may be located on the peripheral region. The voltage drop transistor VDT may be located on the peripheral region, so that the size of the voltage drop transistor VDT may not affect the resolution. Accordingly, the size of the voltage drop transistor VDT may be increased. Accordingly, the threshold voltage dispersion of the voltage drop transistor VDT may be decreased. Accordingly, when the sub-pixel SPX emits light, the compensated power voltage CELVDD may be maintained substantially same voltage. Accordingly, the emission reliability of the sub-pixel SPX may be effectively improved.

FIG. 11 is a circuit diagram illustrating an example of a display panel 100 and a voltage generator 700 of FIG. 1.

Referring to FIG. 11, the voltage drop block 730 may include a plurality of the voltage drop transistors VDT. For example, the voltage drop block 730 may include a first voltage drop transistor and a second voltage drop transistor. The first voltage drop transistor may include a control electrode connected to the compensated power voltage line CELVDDL, a first electrode, which receives the high power voltage ELVDD and a second electrode connected to the compensated power voltage line CELVDDL. The first electrode of the first voltage drop transistor may be connected to the high power voltage line ELVDDL. The second voltage drop transistor may include a control electrode connected to the compensated power voltage line CELVDDL, a first electrode, which receives the high power voltage ELVDD and a second electrode connected to the compensated power voltage line CELVDDL. The first electrode of the second voltage drop transistor may be connected to the high power voltage line ELVDDL.

Additionally, the pixel PX may include a first sub-pixel SPX (e.g., left sub-pixel in FIG. 11) and a second sub-pixel SPX (e.g., right sub-pixel in FIG. 11). The first sub-pixel SPX may be connected to the first data line DL [1]. The second sub-pixel SPX may be connected to the second data line DL [2]. Additionally, the first sub-pixel SPX and the second sub-pixel SPX may be connected to the compensated power voltage line CELVDDL.

The voltage generator of FIG. 11 is substantially same as the voltage generator of FIG. 8 except that the voltage generator further includes a plurality of the voltage drop transistor VDT, so that the same reference numerals will be used and any repetitive explanation concerning the above elements will be omitted.

In the present embodiment, the voltage generator may include a plurality of the voltage drop transistor VDT. Accordingly, when the sub-pixel SPX emits light, the compensated power voltage CELVDD may be maintained substantially same voltage. Accordingly, the emission reliability of the sub-pixel SPX may be further improved.

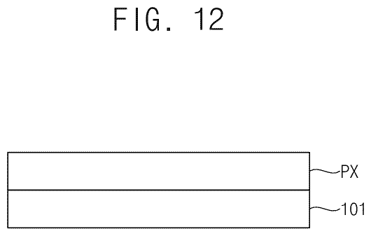

FIG. 12 is a diagram illustrating an example in which a pixel PX of FIG. 1 is located on a substrate 101.

Referring to FIG. 12, the pixel PX may be located on a substrate 101. In an embodiment, the substrate 101 may be a silicon-based substrate. In an embodiment, the pixel PX may be located on a silicon-based substrate. The pixel PX may be located on a silicon-based substrate, so that voltage levels of input signals applied to the pixel PX may be set more precisely.

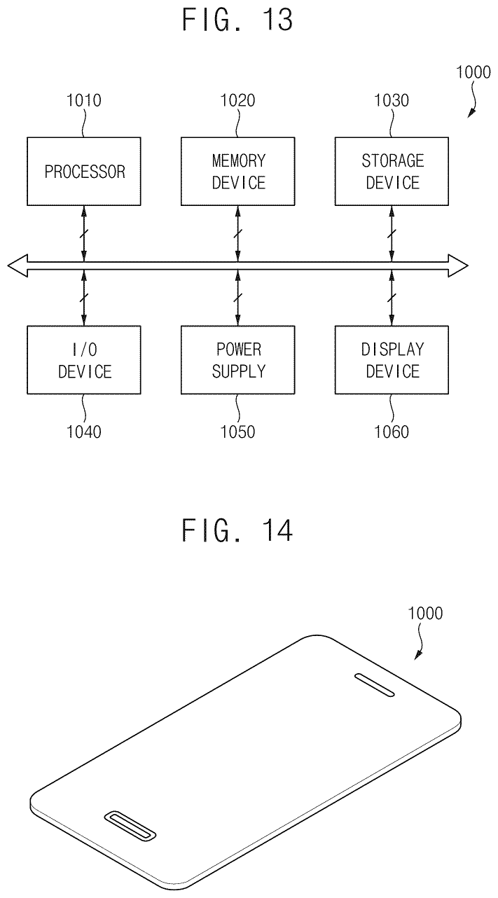

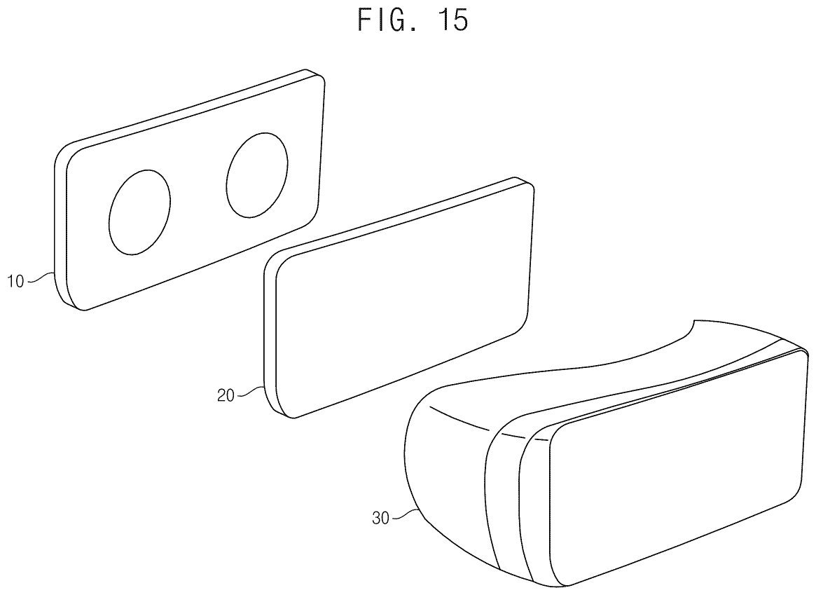

FIG. 13 is a block diagram illustrating an electronic device 1000 according to an embodiment of the present invention. FIG. 14 is a diagram illustrating an example in which the electronic device of FIG. 13 is implemented as a smart phone.

Referring to FIG. 13, the electronic device 1000 may include a processor 1010, a memory device 1020, a storage device 1030, an input/output (I/O) device 1040, a power supply 1050, and a display device 1060. Here, the display device 1060 may be the display device of FIG. 1. Additionally, the electronic device 1000 may further include a plurality of ports for communicating with a video card, a sound card, a memory card, a universal serial bus (USB) device, other electronic devices, etc.

In an embodiment, as illustrated in FIG. 14, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, the app-on signal APPON and the input control signal CONT to the driving controller 200 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display device 1060 may be included in the I/O device 1040. The power supply 1050 may provide power for operations of the electronic device 1000. The display device 1060 may be coupled to other components via the buses or other communication links.

FIG. 15 is a diagram illustrating an example in which the electronic device of FIG. 13 is implemented as a virtual reality display system.

Referring to FIG. 13 and FIG. 15, the virtual reality display system may include a lens unit 10, a display device 20 and a housing 30. The display device 20 is disposed adjacent to the lens unit 10. The housing 30 may receive the lens unit 10 and the display device 20. Although the lens unit 10 and the display device 20 are received in a first side of the housing 30 in FIG. 11, the present invention may not be limited thereto. Alternatively, the lens unit 10 may be received in a first side of the housing 30 and the display device may be received in a second side of the housing 30. When the lens unit 10 and the display device 20 are received in the housing 30 in opposite sides, the housing 30 may have a transmission area to transmit a light.

For example, the virtual reality display system may be a head mounted display system which is wearable on a head of a user. Although not shown in figures, the virtual reality display system may further include a head band to fix the virtual reality display system on the head of the user.

Alternatively, the virtual reality display system may have the form of smart glasses implemented in the shape of glasses.

Additionally, the electronic device may be implemented as an augmented reality display system, a mixed reality display system, or an extended reality display system.

The display device according to the embodiments may be applied to a display device included in a computer, a notebook, a mobile phone, a smart phone, a smart pad, a PMP, a PDA, an MP3 player, or the like.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A display device comprising:
a display panel including a plurality of pixels;
a gate driver configured to output a gate signal to the pixels;
a data driver configured to apply a data voltage to the pixels; and
a voltage generator configured to output a compensated power voltage to the pixels,
wherein the pixels are connected to a compensated power voltage line, and
wherein the voltage generator includes:
a high power voltage generating block configured to output a high power voltage to a voltage drop block; and
the voltage drop block, which outputs the compensated power voltage lower than the high power voltage to the compensated voltage line.

2. The display device of claim 1, wherein the voltage drop block includes a voltage drop element, and
wherein the voltage drop element includes a first electrode, which receives the high power voltage and a second electrode connected to the compensated power voltage line.

3. The display device of claim 2, wherein the voltage drop element is a voltage drop transistor, and
wherein the voltage drop transistor includes a control electrode connected to the compensated power voltage line, a first electrode, which receives the high power voltage and a second electrode connected to the compensated power voltage line.

4. The display device of claim 3, wherein a pixel region on which a pixel of the pixels is located has a first size, and
wherein a voltage drop region on which the voltage drop transistor is located has the first size.

5. The display device of claim 4, wherein the pixel includes first to third sub-pixels, and
wherein the first to third pixels are located on the pixel region having the first size.

6. The display device of claim 4, wherein a size of the voltage drop transistor has the first size.

7. The display device of claim 3, wherein a pixel region on which a pixel of the pixels is located has a first size,
wherein the pixel of the pixels includes a sub-pixel,
wherein a sub-pixel region on which the sub-pixel is located has a second size smaller than the first size, and
wherein a voltage drop region on which the voltage drop transistor is located has the second size.

8. The display device of claim 7, wherein a size of the voltage drop transistor has the second size.

9. The display device of claim 1, further comprising an emission driver configured to output an emission signal to the pixels,
wherein a pixel of the pixels includes a sub-pixel,
wherein the sub-pixel includes:
a first transistor including a control electrode connected to a first node, a first electrode connected to a second node and a second electrode connected to a third node;
a second transistor configured to apply the data voltage to the first node in response to a write gate signal;
a third transistor configured to apply the compensated power voltage to the second node in response to the emission signal;
a fourth transistor configured to output an initialization voltage to the third node in response to a control gate signal; and
a light emitting element including a first electrode connected to the third node and a second electrode, which receives a low power voltage.

10. The display device of claim 9, wherein the second transistor includes a control electrode, which receives the write gate signal, a first electrode, which receives the data voltage and a second electrode connected to the first node,
wherein the third transistor includes a control electrode, which receives the emission signal, a first electrode, which receives the compensated power voltage and a second electrode connected to the second node, and
wherein the fourth transistor includes a control electrode, which receives the control gate signal, a first electrode, which receives the initialization voltage and a second electrode connected to the third node.

11. The display device of claim 10, wherein the sub-pixel further includes:
a first capacitor including a first electrode connected to the first node and a second electrode connected to the second node;
a second capacitor including a first electrode connected to the first node and a second electrode, which receives the initialization voltage; and
a third capacitor including a first electrode connected to the first node and a second electrode connected to the third node.

12. The display device of claim 1, wherein the voltage drop block includes a first voltage drop transistor and a second voltage drop transistor,
wherein the first voltage drop transistor includes a control electrode connected to the compensated voltage power voltage line, a first electrode, which receives the high power voltage and a second electrode connected to the compensated power voltage line, and
wherein the second voltage drop transistor includes a control electrode connected to the compensated voltage power voltage line, a first electrode, which receives the high power voltage and a second electrode connected to the compensated power voltage line.

13. The display device of claim 1, wherein the display panel includes a display region on which the pixels are located, and a peripheral region located adjacent to the display region, and
wherein the voltage drop block is located on the peripheral region.

14. The display device of claim 1, wherein the pixels are located on a silicon-based substrate.

15. A display device comprising:
a display region including a first sub-pixel and a second sub-pixel; and
a panel driver configured to drive the display region,
wherein the panel driver includes a voltage generator configured to apply a compensated power voltage to the display panel,
wherein the voltage generator includes a voltage drop element including a first electrode, which receives a high power voltage and a second electrode connected to a compensated power voltage line, and
wherein the first sub-pixel and the second sub-pixel are connected to the second electrode of the voltage drop element.

16. The display device of claim 15, wherein the first sub-pixel includes:
a first sub-driving transistor configured to generate a first sub-driving current based on a data voltage and the compensated power voltage;
a first sub-emission transistor configured to apply the compensated power voltage to the first sub-driving transistor in response to an emission signal; and
a first sub-light emitting element configured to emit light based on the first sub-driving current,
wherein the second sub-pixel includes:
a second sub-driving transistor configured to generate a second sub-driving current based on the data voltage and the compensated power voltage;
a second sub-emission transistor configured to apply the compensated power voltage to the second sub-driving transistor in response to the emission signal; and
a second sub-light emitting element configured to emit light based on the second sub-driving current, and
wherein a first electrode of the first sub-emission transistor and a first electrode of the second sub-emission transistor are connected to the second electrode of the voltage drop element.

17. The display device of claim 15, wherein the voltage drop element is a voltage drop transistor, and
wherein the voltage drop transistor includes a control electrode connected to the compensated power voltage line, a first electrode, which receives the high power voltage and a second electrode connected to the compensated power voltage line.

18. The display device of claim 15, wherein a first sub-pixel region on which the first sub-pixel is located has a second size, and
wherein a voltage drop region on which the voltage drop element is located has the second size.

19. The display device of claim 18, wherein a size of the voltage drop transistor has the second size.

20. An electronic device comprising:
a display panel including a plurality of pixels;
a gate driver configured to output a gate signal to the pixels;
a data driver configured to apply a data voltage to the pixels;
a voltage generate configured to output a compensated power voltage to the pixels;
a driving controller configured to control the gate driver, the data driver, the voltage generator based on an input control signal; and
a processor configured to output the input control signal,
wherein the pixels are connected to a compensated power voltage line, and
wherein the voltage generator includes:
a high power voltage generating block configured to output a high power voltage to a voltage drop block; and
the voltage drop block, which outputs the compensated power voltage lower than the high power voltage to the compensated voltage line.
